(19) United States
(12) Patent Application Publication
(10) Pub. No.: US 2020/0331172 A1
(43) Pub. Date: Oct. 22, 2020

(54) AN ANTI-STICTION FLEXIBLE MOLD AND A METHOD FOR FABRICATING THE SAME

(71) Applicants: AGENCY FOR SCIENCE, TECHNOLOGY AND RESEARCH, Singapore (SG); WANGI INDUSTRIAL CO. PTE LTD, Singapore (SG)

(72) Inventors: Mark Allen MOXEY, Singapore (SG); Mohamed Sultan Mohiddin SAIFULLAH, Singapore (SG); Karen Siew Ling CHONG, Singapore (SG); Ker Yee CHEW, Singapore (SG)

(21) Appl. No.: 16/303,124

(22) PCT Filed: May 19, 2017
(86) PCT No.: PCT/SG2017/050262

§ 371 Date: Nov. 19, 2018

(30) Foreign Application Priority Data
May 19, 2016 (SG) 10201604029Y

(51) Int. Cl. B29C 33/60; B29C 33/42; B29C 33/40; B29C 33/38; B29C 33/58; B29C 37/00

(52) U.S. Cl. CPC B29C 33/60; B29C 33/424; B29C 33/40; B29C 2033/0005; B29C 33/58; B29C 37/0032; B29C 33/3842

(57) ABSTRACT

This application relates to an anti-stiction flexible mold comprising a layer of an anti-stiction silicon dioxide deposited onto a flexible substrate. There is also provided a method for fabricating an anti-stiction flexible mold comprising the steps of a) depositing a layer of silicon dioxide on a flexible substrate; and b) interacting the layer of silicon dioxide with an anti-stiction agent to form the anti-stiction flexible mold. The resulting anti-stiction flexible mold may have superior anti-stick properties and may enable easy separation of mold and substrates after imprinting.

### TECHNICAL FIELD

The present invention generally relates to an anti-stiction flexible mold and a method for fabricating an anti-stiction flexible mold.

### BACKGROUND ART

Conventional molds for Nanoimprint Lithography (NIL) are made from hard, ridged materials (e.g. silicon, quartz, metals), which are required to withstand the high pressures involved in the imprinting process. However, one major drawback of using these ridged molds is that when imprinting a resist or a pattern onto a ridged substrate, the action of separating the mold from the imprinted substrate (or de-molding) becomes increasingly difficult as the size of the imprinted area increases. This problem arises from the mass accumulation of friction force between the pattern features on the mold and the imprinted resist. The most common approach to resolve this is to apply an anti-stick coating (for example, Perfluorodecyltrichlorosilane or FDTS) onto the surface of the mold to reduce the friction. However, this approach only works for up to a certain imprinted area size. The area size at which de-molding becomes improbable depends largely on the pattern feature size, the pattern aspect ratio and the adhesive properties of the resist being imprinted. Further, such an approach cannot be directly applied to a soft mold because perfluorodecyltrichlorosilane does not bind well to the surface of the soft mold. Another problem encountered in this approach is corrosive etching by hydrochloric acid, a by-product of the reaction of the perfluorodecyltrichlorosilane with the surface of the molds.

There is a need to provide an anti-stiction flexible mold that overcomes, or at least ameliorates, one or more of the disadvantages described above.

There is a need to provide a method for fabricating an anti-stiction flexible mold that overcomes, or at least ameliorates, one or more of the disadvantages described above.

### SUMMARY

According to a first aspect, there is provided an anti-stiction flexible mold comprising a layer of an anti-stiction coated silicon dioxide deposited onto a flexible substrate.

According to a second aspect, there is provided a method for fabricating an anti-stiction flexible mold comprising the steps of: a) depositing a layer of silicon dioxide on a flexible substrate; and b) interacting the silicon dioxide layer with an anti-stiction agent to form the anti-stiction flexible mold.

Advantageously, the provision of a flexible substrate enables the flexible mold to be separated or de-molded from the substrate after imprinting via a peeling back action. This mechanism allows the frictional force encountered during the de-molding step to be localized at the de-molding frontier of the flexible mold and the imprinted resist instead of having to overcome the accumulated frictional force across the total area of the imprint. This mechanism may also aid in at least minimizing or eliminating the relationship between the size of the imprint area and the force required to de-mold, thereby overcoming the limitation of imprinting features onto large areas. Thus, the disclosed method may be used in large-scale imprinting of requisite patterns on substrates with large areas.

More advantageously, the layer of silicon dioxide applied on the flexible mold may provide an optimum surface for optimum chemical adsorption of a fluorinated alkylsilane film such as FDTS, which may enable the flexible mold to obtain superior anti-stick properties. Additionally, the silicon dioxide layer may enable the fluorinated alkylsilane film to be re-applied indefinitely onto the flexible mold. Thus, the problem of corrosive etching by hydrochloric acid that occurs in conventional imprinting does not occur.

Still advantageously, the layer of silicon dioxide may be deposited directly onto the flexible substrate and may not be obtained indirectly by ozone plasma treatment of a polymeric organosilicon layer. In this manner, a more homogenous and uniform layer of silicon dioxide can be deposited onto the flexible substrate as compared to oxidation of the polymeric organosilicon layer, which suffers from decreased size as the organic material is removed from the polymer, leading to a non-homogenous and non-uniform layer. Hence, the disclosed method can be used to pattern a large area.

More advantageously, the flexible substrate is not limited to silicon containing polymeric resists. Hence, the type of substrate is not limited and any type of substrate can be used. Hence, the disclosure may optionally exclude the use of silicon containing polymeric substrates or silicon containing polymeric resists.

Further advantageously, the silicon dioxide layer may protect the integrity of the soft mold structures and may prolong the life of the mold and allow for subsequent reuse of the mold.

### Definitions

The following words and terms used herein shall have the meaning indicated:

The term “anti-stiction”, “anti-stick” or “anti-sticking” as used herein refers to the ability to overcome the static friction between two stationary objects in contact with each other such that relative motion between the two objects is enabled.

The term “curable” refers to the ability of a polymer material to be hardened or toughened by covalent cross-linking of polymer chains, brought about by chemical additives, ultraviolet radiation, electron beam or heat.

The term “UV curable” refers to the ability of a polymer material to be hardened or toughened by covalent cross-linking of polymer chains, brought about by ultraviolet radiation.

The term “flexible” as used herein refers to a material that is deformable or bendable without breaking, such as for example the material is able to be bent to be more than 90° at its mid-point without breaking or become irreversibly damaged. This term is opposite to a “rigid” substrate where the rigid substrate is not able to bend to that extent without breaking.

The term “silane” refers to a compound with the chemical formula SiH₄, which refers to the monomer. Silane polymers are included in the term “silane”.

“Alkyl” as a group or part of a group refers to a straight or branched aliphatic hydrocarbon group, preferably a C₁-C₁₀ alkyl, more preferably C₁-C₆ unless otherwise noted. Examples of suitable straight and branched C₁-C₆ alkyl substituents include methyl, ethyl, n-propyl, 2-propyl, n-butyl, sec-butyl, t-butyl, pentyl, hexyl, heptyl, octyl, nonyl and decyl and the like.

The term “chemisorption” or “chemisorbed” refers to the chemical adsorption arising from a chemical bond formation between an adsorbent and adsorbate, which takes place in a monolayer on the surface of the adsorbent.

“Self-assembled monolayers (SAM)” may refer to molecular assemblies having functional head groups that bind to the particular solid substrate surface and tail groups that are formed spontaneously on surfaces by adsorption and are organized into more or less large ordered domains.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of an anti-stiction flexible mold will now be disclosed.

The anti-stiction flexible mold comprises a layer of an anti-stiction coated silicon dioxide deposited onto a flexible substrate.

The anti-stiction flexible mold may be substantially transparent. The flexible substrate may have a patterned surface or an imprinted surface. The patterned surface may have a plurality of protrusions, recessions, columns or dimples.

The flexible substrate may comprise an ultraviolet (UV) curable resist or a thermal curable resist.

As mentioned above, the material used for the substrate is not limited and may be any resist that is able to be deposited with a layer of silicon dioxide. The resist may be one that is suitable for use with roll-2-roll nanoimprinting. An exemplary resist may be mr-UVCUR-26 resist (obtained from Micro Resist Technology of Germany) or similar resists.

The flexible substrate may comprise of a UV curable resist or a thermal curable resist disposed on a flexible plastic support. The plastic support is not limited and exemplary types of plastic support may be polycarbonate (PC), polymethylmethacrylate (PMMA), polyamides, polyethylene (PE), polysiloxane, polypropylene (PP), polyvinyl chloride (PVC), polyethylene terephthalate (PET) or polydimethylsiloxane (PDMS).

The UV curable resist or a thermal curable resist may not be particularly limited and may be any resist that has a glass transition temperature or melting/sublimation point above 100° C., is flexible and can be a suitable material for the soft mold. Exemplary types of the UV curable resist or a thermal curable resist may be acrylic or epoxy based. Other resist may also be used as long as it has the conditions mentioned above (glass transition temperature or melting/sublimation point above 100° C., is flexible and can be a suitable material for the soft mold)

For the anti-stiction flexible mold, about 90% to about 100% of the surface area of the flexible substrate may be covered by the anti-stiction coated silicon dioxide layer. About 90% to about 91%, about 90% to about 92%, about 90% to about 93%, about 90% to about 94%, about 90% to about 95%, about 90% to about 96%, about 90% to about 97%, about 90% to about 98%, about 90% to about 99%, about 91% to about 100%, about 92% to about 100%, about 93% to about 100%, about 94% to about 100%, about 95% to about 100%, about 96% to about 100%, about 97% to about 100%, about 98% to about 100%, or about 99% to about 100% of the surface area of the flexible substrate may be covered by the anti-stiction coated silicon dioxide layer.

The layer of the anti-stiction coated silicon dioxide may have a thickness of about 9 to about 15 nm, about 10 nm to about 15 nm, about 11 nm to about 15 nm, about 12 nm to about 15 nm, about 13 nm to about 15 nm, about 14 nm to about 15 nm, about 9 nm to about 10 nm, about 9 nm to about 11 nm, about 9 nm to about 13 nm, or about 9 nm to about 14 nm.

The anti-stiction silicon coated dioxide layer may comprise an anti-stiction agent. The anti-stiction agent may be selected form the group consisting of fluorinated alkylsilane, alkylsilane, perfluoroalkyl-phosphonic acid and alkyl-phosphonic acid.

The anti-stiction agent may be a fluorinated alkylsilane. The fluorinated alkylsilane may have the formula R₁—Si—XᵣY₍₄₋ᵣ₎, wherein R₁ is a C₁₋₁₀ alkyl substituted with fluorine; X may be an alkoxy or halo and may be selected from the group consisting of methoxy, ethoxy, propoxy, fluorine, chlorine, bromine and iodine; Y may be an alkoxy, halo or hydrogen and may be selected from the group consisting of methoxy, ethoxy, propoxy, fluorine, chlorine, bromine; and r is an integer selected from the range of 1 to 4 (such as 1, 2, 3 or 4).

The fluorinated alkylsilane may be selected from the group consisting of Perfluorodecyltrichlorosilane (FDTS), trichloroperfluorooctylsilane and perfluorodecyltrialkoxysilane. Hence, the fluorinated alkylsilane may be 1H,1H,2H,2H-perfluorodecyltrichlorosilane, 1H,1H,2H,2H-perfluorodecyltrichlorosilane, trichloro(1H,1H,2H,2H-perfluorooctyl)silane, or 1H,1H,2H,2H-perfluorodecyltrimethoxysilane.

The alkylsilane may be octadecyltrichlorosilane. The perfluoroalkyl-phosphonic acid may be 1H,1H,2H,2H-Perfluoro-n-octylphosphonic acid. The alkyl-phosphonic acid may be octadecylphosphonic acid.

Exemplary, non-limiting embodiments of a method for fabricating an anti-stiction flexible mold will now be disclosed.

The method for fabricating an anti-stiction flexible mold may comprise the steps of depositing a layer of silicon dioxide on a flexible substrate; and interacting the layer of silicon dioxide with an anti-stiction agent to form said anti-stiction flexible mold.

The anti-stiction flexible mold may be substantially transparent.

The silicon dioxide, or SiO₂ (or silica), may be deposited directly onto the flexible substrate. The layer of silicon dioxide may be deposited by chemical vapour deposition or by physical vapour deposition. The silicon dioxide layer may be formed on the surface of the flexible substrate by oxidizing a silicon-containing gas in the presence of an oxygen containing gas. Hence, the method may optionally exclude the step of oxidizing a polymeric organosilicon compound on the surface of a flexible substrate to form a layer of silicon dioxide. Where physical vapour deposition is used to deposit the silicon dioxide, the silicon dioxide may be deposited by Radio Frequency sputtering, which uses silicon dioxide as the target. The conditions used for radio frequency sputtering are not limited and would be as known to a person skilled in the art. As an example, the radio frequency sputtering is carried out at room temperature (about 25° C., a deposition rate of 0.3 A/s, a coating pressure of 1×10⁻⁵ Torr and an oxygen gas flow rate of 20 sccm. By using radio frequency sputtering, the resultant layer may have a (1) denser coating of silicon dioxide, (2) better uniform coverage of silicon dioxide, (3) better control and range of the thickness of the silicon dioxide layer and/or (4) higher purity of the silicon dioxide layer. In addition, having a more homogeneous layer of the silicon dioxide may result in lowered surface energy when coated with the anti-stiction agent as the density of the anti-stiction agent will be directly affected by the uniformity and purity of the silicon dioxide layer.

The method may also comprise the step of depositing the layer of silicon dioxide to form a homogenous layer of silicon dioxide on the surface of the flexible substrate. Hence, the homogenous layer of silicon dioxide may be a uniform packing of the silicon dioxide molecules in the layer. The layer of silicon dioxide may be deposited such that about 90% to about 100% of the surface area of the flexible substrate may be covered by the anti-stiction coated silicon dioxide layer. About 90% to about 91%, about 90% to about 92%, about 90% to about 93%, about 90% to about 94%, about 90% to about 95%, about 90% to about 96%, about 90% to about 97%, about 90% to about 98%, about 90% to about 99%, about 91% to about 100%, about 92% to about 100%, about 93% to about 100%, about 94% to about 100%, about 95% to about 100%, about 96% to about 100%, about 97% to about 100%, about 98% to about 100%, or about 99% to about 100% of the surface area of the flexible substrate may be covered by the anti-stiction coated silicon dioxide layer.

The layer of silicon dioxide may be a sputtered layer of silicon dioxide.

The layer of silicon dioxide may be an inorganic layer which does not contain any organic groups. The layer of silicon dioxide may contain only silicon and oxygen atoms.

The layer of silicon dioxide may have a thickness of about 9 to about 15 nm, about 10 nm to about 15 nm, about 11 nm to about 15 nm, about 12 nm to about 15 nm, about 13 nm to about 15 nm, about 14 nm to about 15 nm, about 9 nm to about 10 nm, about 9 nm to about 11 nm, about 9 nm to about 13 nm, or about 9 nm to about 14 nm. The thickness of the silicon dioxide layer may not be uniform across the entire substrate (that is the thickness may not be the same value across the entire surface), however, any difference in the thickness from one point to the other may be around 0.3%.

The method may further comprise the step of reacting or treating the layer of silicon dioxide with the anti-stiction agent by chemical adsorption to form a self-assembled monolayer (SAM). The monolayer may be a densely packed, covalently bonded monolayer.

The anti-stiction agent may coat the silicon dioxide layer such that a layer of an anti-stiction coated silicon dioxide may be formed. Hence, the interacting step may be regarded as a coating step.

The anti-stiction agent may be selected form the group consisting of fluorinated alkylsilane, alkylsilane, perfluoroalkyl-phosphonic acid and alkyl-phosphonic acid.

The anti-stiction agent may be a fluorinated alkylsilane. The fluorinated alkylsilane may have the formula R₁—Si—XᵣY₍₄₋ᵣ₎, wherein R₁ is a C₁₋₁₀ alkyl substituted with fluorine; X may be an alkoxy or halo and may be selected from the group consisting of methoxy, ethoxy, propoxy, fluorine, chlorine, bromine and iodine; Y may be an alkoxy, halo or hydrogen and may be selected from the group consisting of methoxy, ethoxy, propoxy, fluorine, chlorine, bromine; and r is an integer selected from the range of 1 to 4 (such as 1, 2, 3 or 4).

The fluorinated alkylsilane may be selected from the group consisting of Perfluorodecyltrichlorosilane (FDTS), trichloroperfluorooctylsilane and perfluorodecyltrialkoxysilane. Hence, the fluorinated alkylsilane may be 1H,1H,2H,2H-perfluorodecyltrichlorosilane, 1H,1H,2H,2H-perfluorodecyltrichlorosilane, trichloro(1H,1H,2H,2H-perfluorooctyl)silane, or 1H,1H,2H,2H-perfluorodecyltrimethoxysilane.

The alkylsilane may be octadecyltrichlorosilane. The perfluoroalkyl-phosphonic acid may be 1H,1H,2H,2H-Perfluoro-n-octylphosphonic acid. The alkyl-phosphonic acid may be octadecylphosphonic acid.

Chemisorption or chemical adsorption of fluorinated anti-stiction agent may occur via cleavage of at least one of the Si-halogen or Si-alkoxy bonds at the terminal silane group and subsequent formation of at least one covalent Si—O bond to the surface of the evaporated SiO₂ layer. The halogen may be selected from the group consisting of fluorine, chlorine, bromine and iodine. The Si—OH groups then react with the surface Si—OH groups (present on the SiO₂ layer) in a condensation reaction that bonds the silane to the surface through a Si—O—Si bond.

Conventional methods to incorporate a fluorinated alkylsilane to the mold surface requires a first step of depositing a layer of Polydimethylsiloxane (PDMS) onto the mold surface, followed by a second step of oxidation with O₂ plasma to provide reactive groups on the surface of the deposited layer of PDMS prior to the chemisorption of fluorinated silane. FIG. 5 (a) (prior art) depicts a chemisorbed SAM using oxidised PDMS (404) as the surface for covalent bonding to a fluorinated alkylsilane (402). Advantageously, the present disclosure provides an approach to directly incorporate a fluorinated alkylsilane to a mold without any oxidation step. Accordingly, the present disclosure provides a step of depositing a layer of silicon dioxide onto the mold surface, which instantly provides a homogenous surface for chemisorption of fluorinated silane. As shown in FIG. 5 (b), this layer of silicon dioxide (406) also provides optimum coverage for chemisorption of a fluorinated alkylsilane (402) and yields a densely packed, covalently bonded SAM. The density of the monolayer may be quantified by measuring the water contact angle on a non-patterned sample and comparing the result with literature values of well characterised, densely packed monolayers. Any deviation from the maximum range found in literature would suggest an incomplete monolayer.

The flexible substrate may have a patterned surface or an imprinted surface. The patterned surface may have a plurality of protrusions, recessions, columns or dimples.

The flexible substrate may comprise an ultraviolet (UV) curable resist or a thermal curable resist.

As mentioned above, the material used for the substrate is not limited and may be any resist that is able to be deposited with a layer of silicon dioxide. The resist may be one that is suitable for use with roll-2-roll nanoimprinting. An exemplary resist may be mr-UVCUR-26 resist (obtained from Micro Resist Technology of Germany) or similar resists.

The flexible substrate may comprise of a UV curable resist or a thermal curable resist disposed on a flexible plastic support.

The plastic support is not limited and exemplary types of plastic support may be polycarbonate (PC), polymethylmethacrylate (PMMA), polyamides, polyethylene (PE), polysiloxane, polypropylene (PP), polyvinyl chloride (PVC), polyethylene terephthalate (PET) or polydimethylsiloxane (PDMS).

The UV curable resist or a thermal curable resist may not be particularly limited and may be any resist that has a glass transition temperature or melting/sublimation point above 100° C., is flexible and can be a suitable material for the soft mold. Exemplary types of the UV curable resist or a thermal curable resist may be acrylic or epoxy based. Other resist may also be used as long as it has the conditions mentioned above (glass transition temperature or melting/sublimation point above 100° C., is flexible and can be a suitable material for the soft mold).

The anti-stiction flexible mold may be used in nanoimprint lithography. The anti-stiction flexible mold may be used to imprint patterns or features on rigid or flexible substrates. The dimensions for the surface area of rigid or flexible substrates are not particularly limited and may be up to about 50 cm by up to about 50 cm, up to about 24 cm by up to about 28 cm, up to about 24 cm by up to about 29 cm, up to about 24 cm by up to about 30 cm, up to about 23 cm by up to about 28 cm, up to about 22 cm by up to about 28 cm, up to about 21 cm by up to about 28 cm, up to about 20 cm by up to about 28 cm, up to about 20 cm by up to about 30 cm, up to about 25 cm by up to about 30 cm, or up to about 20 cm by up to about 25 cm.

The surface area of the rigid or flexible substrate to be imprinted may be at least 2500 cm², or at least 100 cm². The surface area may be at least about 100 cm², at least about 125 cm², at least about 150 cm², at least about 175 cm², at least about 200 cm², at least about 225 cm², at least about 250 cm², at least about 275 cm², at least about 300 cm², at least about 325 cm², at least about 350 cm², at least about 375 cm², at least about 400 cm², at least about 425 cm², at least about 450 cm², at least about 475 cm², at least about 500 cm², at least about 525 cm², at least about 550 cm², at least about 575 cm², at least about 600 cm², at least about 700 cm², at least about 800 cm², at least about 900 cm², at least about 1000 cm², at least about 1100 cm², at least about 1200 cm², at least about 1300 cm², at least about 1400 cm², at least about 1500 cm², at least about 1600 cm², at least about 1700 cm², at least about 1800 cm², at least about 1900 cm², at least about 2000 cm², at least about 2100 cm², at least about 2200 cm², at least about 2300 cm², at least about 2400 cm², or at least about 2500 cm².

The anti-stiction flexible mold may be used to imprint patterns or features on rigid substrates. The rigid substrates may be selected from the group consisting of glass, acrylics, polycarbonates, thermoplastics.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic diagram depicting a representative cross sectional side view of an anti-stiction flexible mold.

FIG. 2 is a schematic diagram depicting the de-molding process utilizing the anti-stiction flexible mold as disclosed herein.

FIG. 3 is a schematic diagram illustrating a general method of fabricating the anti-stiction flexible mold.

FIG. 4 is a schematic diagram illustrating a general process of imprinting a pattern on a hard substrate using the anti-stiction flexible mold.

FIG. 5 is a diagram illustrating a comparison between (a) a layer of silicon dioxide formed by chemisorption of a fluorinated alkylsilane onto the surface of a layer of a polymeric organosilicon compound that has been oxidized with O₂ plasma, and (b) a layer formed by chemisorption of a fluorinated alkylsilane onto the surface of a layer of silicon dioxide that has been deposited directly onto the substrate.

### DETAILED DESCRIPTION OF DRAWINGS

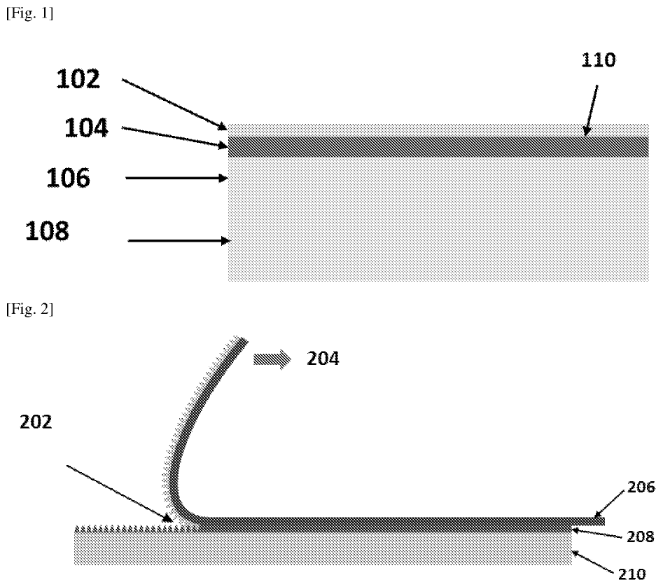

Referring to FIG. 1, there is shown a representative cross-sectional side view diagram of an anti-stiction flexible mold showing a fluorinated alkylsilane (102) layer that interacted with a layer of silicon dioxide (104) that is provided on a flexible substrate made up of a UV curable resist (106) and a flexible substrate (108). The fluorinated alkylsilane (102) layer is chemisorbed onto the layer of silicon dioxide (104) to form a self-assembled monolayer (SAM) (110).

Referring to FIG. 2, there is shown a schematic diagram depicting the de-molding process utilizing the anti-stiction flexible mold (206). The anti-stiction flexible mold (206) was used to imprint a pattern on a rigid substrate (210) and subsequently removed from the rigid substrate (210) in a de-molding process. In the de-molding process, the frictional force is localized at the de-molding frontier (202) when the anti-stiction flexible mold (206) is separated from the UV curable resist (208) that is sandwiched between the anti-stiction flexible mold (206) and the rigid substrate (210) during a peeling action (204).

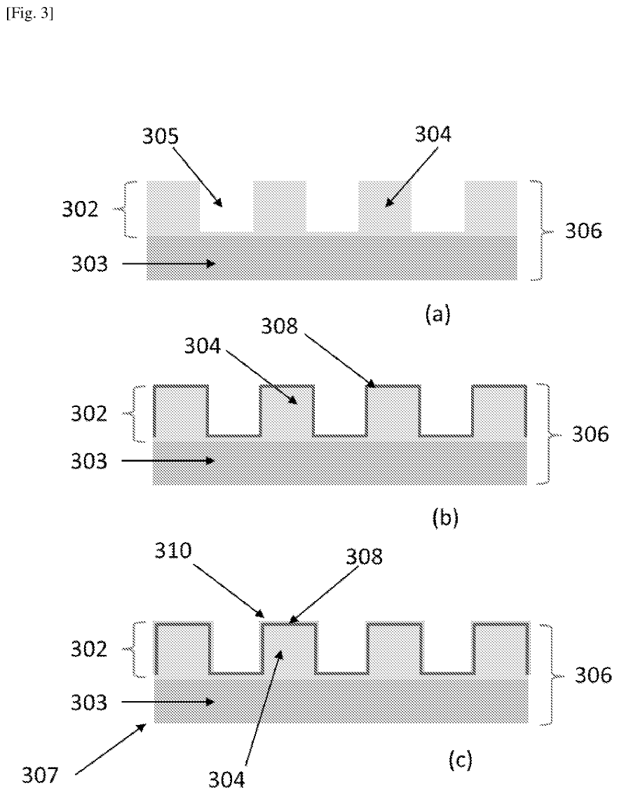

Referring to FIG. 3, there is shown a general method of fabricating the anti-stiction flexible mold. Here, FIG. 3(a) shows a flexible substrate (306) having a patterned UV curable resist (302) with a plurality of protrusions (304) and depressions (305). The UV curable resist (302) is provided on a flexible polymeric support (303). Hence, the flexible substrate (306) is made up of the UV curable resist (302) and the flexible polymeric support (303). In FIG. 3(b), a layer of silicon dioxide (308) is deposited directly onto the flexible substrate (306). In FIG. 3(c), a layer of fluorinated alkylsilane (310) is coated onto the layer of silicon dioxide (308) to cause the fluorinated alkylsilane to interact or react with the silicon dioxide in the silicon dioxide layer (308). The resultant anti-stiction flexible mold is thus defined by reference numeral 307.

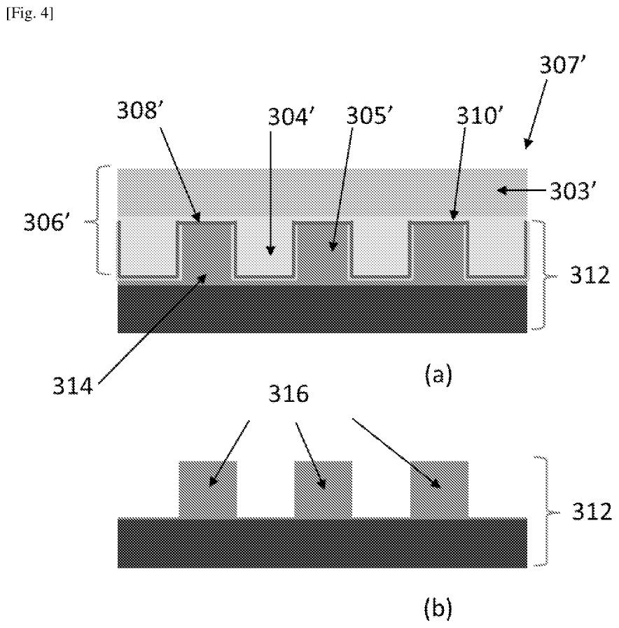

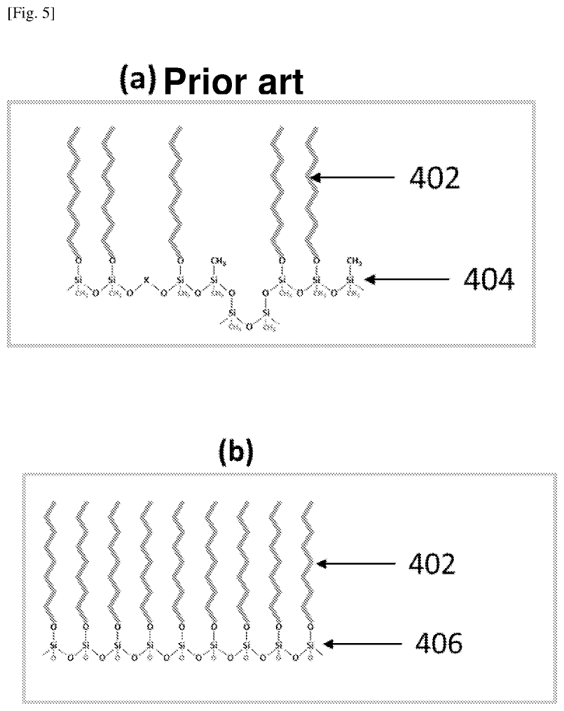

Referring to FIG. 4, like reference numerals as those in FIG. 3 are used to define like features but are depicted with a prime (′) symbol. FIG. 4 is a schematic diagram illustrating a general process of imprinting a pattern on a hard substrate using the anti-stiction flexible mold (307′). In FIG. 4(a), the anti-stiction flexible mold (307′) is compressed with a hard substrate (312) coated with a UV curable resist (314) that is conformable to the protrusions (304′) and depressions (305′) of the anti-stiction flexible mold (307′). Hence, the protrusions on the UV curable resist (314) correspond to the depressions (305′) of the anti-stiction flexible mold (307′) while the depressions of the UV curable resist (314) correspond to the protrusions (304′) of the anti-stiction flexible mold (307′). The hard substrate (312) in contact with the anti-stiction flexible mold (307′) is then subjected to ultraviolet treatment to cure the UV curable resist (314) to form the resultant pattern. In FIG. 4(b), the anti-stiction flexible mold (307′) is removed from the UV curable resist (314) in a de-molding process leaving a patterned UV curable resist (314) on the hard substrate (312).

Referring to FIG. 5, FIG. 5(a) shows a self-assembled monolayer formed by chemisorption of a fluorinated alkylsilane (402) onto the surface of a PDMS layer (404) that has been oxidized with O₂ plasma, while FIG. 5(b) shows a self-assembled monolayer formed by chemisorption of a fluorinated alkylsilane (402) onto the surface of a layer of silicon dioxide (406). In comparing between FIG. 5(a) and FIG. 5(b), it can be seen that in FIG. 5(b), a more homogeneous layer of the silicon dioxide is formed as compared to that in FIG. 5(a). In addition, the silicon dioxide layer in FIG. 5(b) is an inorganic silicon dioxide layer that does not have any organic groups or moieties attached to the silicon atom. This thereby allows for enhanced interaction between the oxygen atoms of the silicon dioxide layer in FIG. 5(b) and the fluorinated alkylsilane (402).

### EXAMPLES

Non-limiting examples of the invention and a comparative example will be further described in greater detail by reference to specific Examples, which should not be construed as in any way limiting the scope of the invention.

### Example 1

Preparation of a Flexible Substrate with an Imprinted Resist Layer

A flexible substrate with an imprinted resist layer was fabricated using an automated roll-2-roll (R2R) nanoimprinter tool. The R2R tool was loaded with a roll of polycarbonate (PC) film (thickness of about 0.17 mm) and the resist reservoir was filled with mr-UVCUR-26 resist (obtained from Micro Resist Technology of Germany). The R2R tool used an inject printer head to disperse the resist onto the PC film as it was wound by the automated roller system. The resist coated PC film was then passed between rollers. The top roller had a nickel mold attached and mold pressed the resist as the PC film passed through. As the resist was imprinted by the nickel mold, it was simultaneously cured by UV light emitted from an LED source. Once all imprinting was completed, the regions of imprinted resist on the PC film can be cut away from the rest of the film.

### Deposition of an Evaporated Layer of SiO₂ on a Flexible Substrate

The silicon dioxide layer was deposited onto the resist by radio frequency sputtering using silicon dioxide as the target, a coating temperature of room temperature (about 25° C.), a deposition rate of 0.3 A/s, a coating pressure of 1×10⁻⁵ Torr and an oxygen gas flow rate of 20 sccm.

### Deposition of FDTS

The SiO₂ coated resist was placed into a desiccator containing a small volume (approx. 50 μL) of 1H,1H,2H,2H-perfluorodecyltrichlorosilane (FDTS) in a glass vial. The desiccator was sealed and placed under vacuum. The desiccator was kept at reduced pressure for up to 12 hours at room temperature. During this time, the FDTS was vaporized and deposited onto the surface of the resist and chemisorbed to the SiO₂ layer.

### Imprinting

The above resist was then used as a mold to imprint a UV curable resist on a glass substrate of an area of 120 mm×200 mm. When the resist mold was removed from the glass substrate, it was observed that the resist mold was able to be demolded from the UV curable resist easily and the entire UV curable resist (that is 100%) was imprinted by the resist mold.

### Comparative Example

### Preparation of PDMS Molds

PDMS molds were prepared by mixing Sylgard 184 elastomer (PDMS) with a curing agent and pouring the mixture over a hard mold (nickel or silicon) that had been pre-treated with an anti-stick coating. The PDMS coated mold was then cured in an oven at 70° C. for about 12 hours. The PDMS layer was pealed from the hard mold and placed in a chamber and exposed to ozone to oxidise the surface. The oxidised PDMS mold was then placed into a desiccator with a small volume of FDTS and held under vacuum for up to 12 hours to coat the PDMS surface with FDTS. The PDMS mold was then used to imprint a UV curable resist on glass substrate. When the PDMS mold was removed from the glass substrate, it was observed that about 60%-70% of the UV curable resist had remained on the glass substrate and was imprinted. The other 30%-40% of the UV curable resist was stuck to the PDMS mold. Hence, the PDMS mold was not able to be demolded from the UV curable mold completely.

### INDUSTRIAL APPLICABILITY

The flexible mold formed by the method of the present disclosure may be applied to facilitate the imprinting of beneficial structured coatings on rigid substrates over relatively large areas (more than 100 cm²), for example, anti-reflective coating on glass panels for display screens.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1.-24. (canceled)

25. An anti-stiction flexible mold comprising a layer of an anti-stiction silicon dioxide deposited onto a flexible substrate, wherein said anti-stiction silicon dioxide layer has a thickness of 9 to 15 nm.

26. The anti-stiction flexible mold according to claim 25, wherein said anti-stiction flexible mold is substantially transparent.

27. The anti-stiction flexible mold according to claim 25, wherein the flexible substrate has a patterned surface.

28. The anti-stiction flexible mold according to claim 25, wherein the flexible substrate comprises an ultraviolet curable resist or a thermal curable resist.

29. The anti-stiction flexible mold according to claim 28, wherein the flexible substrate is an acrylic or epoxy based resist.

30. The anti-stiction flexible mold according to claim 25, wherein 90% to 100% of the surface area of the flexible substrate is covered by said anti-stiction silicon dioxide layer.

31. The anti-stiction flexible mold according to claim 25, wherein said anti-stiction silicon dioxide layer comprises an anti-stiction agent that is selected from the group consisting of fluorinated alkylsilane, alkylsilane, perfluoroalkyl-phosphonic acid and alkyl-phosphonic acid.

32. The anti-stiction flexible mold according to claim 31, wherein the fluorinated alkylsilane is of the formula R₁—Si—XᵣY₍₃₋ᵣ₎, wherein R₁ is a C₁₋₁₀ alkyl substituted with fluorine; X is an alkoxy or a halo; Y is an alkoxy, a halo or hydrogen; and r is an integer selected from the range of 1 to 3 or wherein the fluorinated alkylsilane is selected from the group consisting of perfluorodecyltrichlorosilane (FDTS), trichloroperfluorooctylsilane and perfluorodecyltrialkoxysilane.

33. A method for fabricating an anti-stiction flexible mold comprising:
(a) depositing a layer of silicon dioxide on a flexible substrate; and
(b) interacting said layer of silicon dioxide with an anti-stiction agent to form said anti-stiction flexible mold, wherein said interacting operation (b) comprises the operation of vaporizing the anti-stiction agent.

34. The method according to claim 33, wherein the vaporized anti-stiction agent is deposited onto the layer of silicon dioxide.

35. The method according to claim 33, wherein the anti-stiction flexible mold is substantially transparent.

36. The method according to claim 33, wherein the flexible substrate in operation (a) has a patterned surface or comprises an ultraviolet curable resist or thermal curable resist.

37. The method according to claim 36, wherein the flexible substrate is an acrylic or epoxy based resist.

38. The method according to claim 33, wherein said depositing operation (a) comprises an operation of depositing the layer of silicon dioxide by chemical vapour deposition or by physical vapour deposition.

39. The method according to claim 33, wherein said depositing operation (a) comprises an operation of forming a homogenous layer of silicon dioxide on the surface of the flexible substrate.

40. The method according to claim 33, wherein the layer of silicon dioxide deposit has a thickness of 9 to 15 nm.

41. The method according to claim 33, wherein said interacting operation (b) comprises an operation of reacting the layer of silicon dioxide with the anti-stiction agent by chemical adsorption to form a self-assembled monolayer.

42. The method according to claim 33, wherein the anti-stiction agent is selected from the group consisting of fluorinated alkylsilane, alkylsilane, perfluoroalkyl-phosphonic acid and alkyl-phosphonic acid.

43. The method according to claim 42, wherein the fluorinated alkylsilane is of the formula R₁—Si—XᵣY₍₃₋ᵣ₎, wherein R₁ is a C₁₋₁₀ alkyl substituted with fluorine; X is an alkoxy or a halo; Y is an alkoxy, a halo or hydrogen; and r is an integer selected from the range of 1 to 3 or wherein the fluorinated alkylsilane is selected from the group consisting of Perfluorodecyltrichlorosilane (FDTS), trichloroperfluorooctylsilane and perfluorodecyltrialkoxysilane.

44. An anti-stiction flexible mold produced by a method for fabricating an anti-stiction flexible mold comprising:
(a) depositing a layer of silicon dioxide on a flexible substrate; and
(b) interacting said layer of silicon dioxide with an anti-stiction agent to form said anti-stiction flexible mold, wherein said interacting operation (b) comprises the operation of vaporizing the anti-stiction agent.
